(19) United States
(12) Patent Application Publication
(10) Pub. No.: US 2018/0355153 A1
(43) Pub. Date: Dec. 13, 2018

(54) REINFORCED RUBBER COMPOSITION FOR A TIRE

(71) Applicants: COMPAGNIE GENERALE DES ETABLISSEMENTS MICHELIN, Clermont-Ferrand (FR); Michelin Recherche et Technique S.A., Granges-Paccot (CH)

(72) Inventors: VINCENT ABAD, CLERMONT-FERRAND (FR); ROMAIN LIBERT, CLERMONT-FERRAND (FR)

(21) Appl. No.: 15/535,727

(22) PCT Filed: Dec. 14, 2015
(86) PCT No.: PCT/EP2015/079536

§ 371 Date: Jun. 14, 2017

(30) Foreign Application Priority Data
Dec. 15, 2014 (FR) 1462415

(51) Int. Cl. C08L 9/06; C08K 3/06; C08K 3/22; C08K 3/38; C08K 5/00; C08K 5/435; C08K 5/09; B60C 1/00

(52) U.S. Cl. CPC C08L 9/06; C08K 3/06; C08K 3/22; C08K 3/38; C08K 5/0016; C08K 2201/006; C08K 5/09; B60C 1/0016; C08K 2003/385; C08K 2003/2296; C08K 5/435

(57) ABSTRACT

The invention relates to a tyre comprising at least one rubber composition based on at least one diene elastomer, a reinforcing filler, a plasticizing system and a crosslinking system, characterized in that the composition comprises hexagonal boron nitride having a BET specific surface area of greater than or equal to 10 m²/g as reinforcing filler, at a content ranging from 30 to 350 parts per hundred parts of elastomer, phr, and a coupling agent capable of binding the boron nitride to the diene elastomer.

The present invention relates to reinforced diene rubber compositions intended for the manufacture of tyres or of semi-finished products for tyres, in particular of treads of these tyres.

It is known that, in order to obtain the optimum reinforcing properties imparted by a filler to a tyre tread, and thus to obtain high wear resistance, it is generally advisable for this filler to be present in the elastomer matrix in a final form that is both as finely divided as possible and as uniformly distributed as possible. However, such conditions can be achieved only if this filler has a very good capacity, on the one hand, to be incorporated into the matrix during the mixing with the elastomer and to deagglomerate, and, on the other hand, to disperse uniformly in this matrix.

Since fuel savings and the need to protect the environment have become a priority, it has proved necessary to produce tyres having a reduced rolling resistance without adversely affecting their wear resistance. This has been made possible especially by virtue of the discovery of rubber compositions reinforced with specific inorganic fillers described as “reinforcing”, especially “highly dispersible” silicas, which are capable of rivalling, from the reinforcing viewpoint, a conventional tyre-grade carbon black, while affording these compositions a lower hysteresis, which corresponds to lower rolling resistance for the tyres comprising them. However, it remains beneficial to discover novel reinforcing fillers which may constitute an alternative to highly dispersible silicas.

Moreover, it is important, in tyres, to reduce the very significant internal heating of the reinforcing belt, which may lead to modification of its normal operation or to degradation of the tyre. It is therefore necessary for these solutions to be able to be accompanied by a significant improvement in the discharge of heat through the tread, hence to improve the thermal conductivity properties thereof.

Some solutions have been proposed, consisting in the use of reinforcing fillers, the thermal conductivity properties of which are recognized, such as acetylene-derived carbon blacks. Thus, for example, the publication EP 1 767 570 proposes different blends of “more conventional” carbon blacks, of acetylene-derived carbon blacks and of silica in treads, combined with high contents of plasticizers (of the order of 100 parts per hundred parts by weight of elastomer, phr).

However, the use of such amounts of plasticizers leads to a degradation of the mechanical and hysteresis properties of the treads obtained in this way.

Another solution proposed by the publication US 2010/0000650 consists in adding to the reinforcing filler, in particular carbon black, or in partially replacing this filler with boron nitride, into a tire rubber composition, in order to improve the thermal conductivity However, a full replacement of the reinforcing filler is not envisaged, since those skilled in the art know that such a solution would lead to a degradation of the mechanical properties of the composition in question. This is because the method for obtaining rubber compositions containing boron nitride as described in this invention would lead to a lessening of the mechanical properties and also to a degradation of the wear resistance of the compositions obtained in this way.

The applicant has discovered, surprisingly, that boron nitrides on their own could constitute, unlike the preconceptions of those skilled in the art, novel reinforcing fillers for rubber compositions for tyres, capable of rivalling silicas and making it possible to obtain improved conductivity properties without degrading the other properties of the composition. Particularly astonishingly, these compositions have a much lower hysteresis than that of a composition comprising silica as reinforcing filler.

The subject of the invention is at least one rubber composition based on at least one diene elastomer, a reinforcing filler, a plasticizing system and a crosslinking system, characterized in that the composition comprises hexagonal boron nitride having a BET specific surface area of greater than or equal to 10 m²/g as reinforcing filler, at a content ranging from 30 to 350 parts per hundred parts of elastomer, phr, and a coupling agent capable of binding the boron nitride to the diene elastomer.

The boron nitride preferably has a specific surface area of greater than or equal to 15 m²/g, more preferentially greater than or equal to 20 m²/g.

Advantageously, the diene elastomer is selected from the group consisting of polybutadienes, synthetic polyisoprenes, natural rubber, butadiene copolymers, isoprene copolymers and the mixtures of these elastomers.

In particular, the diene elastomer represents at least 50% by weight of all the elastomers present in the composition.

The invention also relates to a tyre comprising a composition as described above, which at least partially constitutes the tread.

### I. MEASUREMENTS AND TESTS USED

### BET Specific Surface Area

The BET specific surface area of the boron nitride particles is determined by gas adsorption using the Brunauer-Emmett-Teller method described in The Journal of the American Chemical Society, Vol. 60, page 309, February 1938, more specifically, according to French Standard NF ISO 9277 of December 1996 [multipoint (5 point) volumetric method—gas:nitrogen—degassing: 1 hour at 160° C.—relative pressure p/po range: 0.05 to 0.17].

### Thermal Diffusivity

The diffusimetry experiment consists in measuring the diffusivity of our material. Diffusivity corresponds to the rate per unit area of penetration and attenuation of a heat wave in a medium.

D=λ/(ρ·C)(in m²/s)

where
λ is the thermal conductivity of the material, in [W·m⁻¹·K⁻¹]
ρ is the density of the material, in [kg·m⁻³]
C is the heat capacity of the material, in [J·kg⁻¹·K⁻¹]:

The measurement is carried out on a NETZSCH LFA447 instrument. The measurement principle is based on a rubber sample subjected to a pre-regulated flash from a xenon lamp. The capacitor enables a voltage of between 190 V and 304 V to be sent to the lamp. The xenon lamp thus emits a flash which causes a rise in temperature at the sample. An infrared sensor detects the temperature rise and delivers a voltage. This voltage may be amplified if its amplitude is insufficient. The output thermogram enables the diffusivity to be determined using the analysis software. The software is based on the Cape-Lehman model, considering the total integration of the energy emitted.

### Preparation of the Samples:

Cutting of the Samples:

A disc 12 mm in diameter must be cut using a punch from approximately 2 mm thick slabs of cured mixtures.

Homogenization of the Samples:

Once the samples have been cut, 3 layers of graphite must be applied in order to obtain uniform and conducting measurement surfaces.

Graphite varnish is applied by means of rapid spraying approximately 30 centimetres from the sample.

Thickness of the Samples:

The thickness of the samples is important for determining diffusivity.

The thickness of the samples is measured by means of a Mitutoyo micrometer, which is accurate to within one micron.

### Tensile Tests

These tensile tests make it possible to determine the moduli of elasticity and the properties at break and are based on French standard NF T 46-002 of September 1988. Processing the tensile recordings also makes it possible to plot the curve of modulus as a function of the elongation, the modulus used here being the nominal (or apparent) secant modulus measured in first elongation, calculated by reducing to the initial cross section of the test specimen. The nominal secant moduli (or apparent stresses, in MPa) are measured in first elongation, at 23° C.±2° C., at 10%, 100% and 300% elongation, respectively denoted MSA10, MSA100 and MSA300.

### Dynamic Properties

The dynamic property tan(δ)ₘₐₓ is measured on a viscosity analyser (Metravib VA4000) according to standard ASTM D 5992-96. The response of a sample of vulcanized composition (cylindrical test specimen with a thickness of 4 mm and with a cross section of 400 mm²), subjected to a simple alternating sinusoidal shear stress, at a frequency of 10 Hz, is recorded under standard temperature conditions (23° C.) according to Standard ASTM D 1349-99 or, as the case may be, at a different temperature; in the examples, the measurement temperature is 23° C. A strain amplitude sweep is carried out from 0.1% to 45% (outward cycle) and then from 45% to 0.1% (return cycle). The result made use of is the loss factor tan(δ). For the return cycle, the maximum value of tan(δ) observed, denoted tan(δ)ₘₐₓ, is indicated.

### II. DETAILED DESCRIPTION OF THE INVENTION

The present invention relates to a tyre comprising at least one rubber composition based on at least one diene elastomer, a reinforcing filler, a plasticizing agent and a crosslinking system, characterized in that the composition comprises “nanometric scale” hexagonal boron nitride as reinforcing filler, at a content ranging from 30 to 250 parts per hundred parts of elastomer, phr, and a coupling agent capable of binding the boron nitride to the diene elastomer.

In the present description, unless expressly indicated otherwise, all the percentages (%) shown are % by weight. Furthermore, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

### Diene Elastomer

The term “diene” elastomer or rubber should be understood, in a known way, as meaning an (one or more is understood) elastomer resulting at least in part (i.e., a homopolymer or a copolymer) from diene monomers (monomers bearing two conjugated or non-conjugated carbon-carbon double bonds).

These diene elastomers can be classified into two categories: “essentially unsaturated” or “essentially saturated”. “Essentially unsaturated” is generally understood to mean a diene elastomer resulting at least in part from conjugated diene monomers having a content of units of diene origin (conjugated dienes) which is greater than 15% (mol %); thus, diene elastomers such as butyl rubbers or copolymers of dienes and of α-olefins of EPDM type do not come within the preceding definition and can especially be described as “essentially saturated” diene elastomers (low or very low content, always less than 15%, of units of diene origin). In the category of “essentially unsaturated” diene elastomers, “highly unsaturated” diene elastomer is understood in particular to mean a diene elastomer having a content of units of diene origin (conjugated dienes) which is greater than 50%.

Given these definitions, “diene elastomer capable of being used in the compositions in accordance with the invention” is intended more particularly to mean:

(a)—any homopolymer obtained by polymerization of a conjugated diene monomer having from 4 to 12 carbon atoms;
(b)—any copolymer obtained by copolymerization of one or more conjugated dienes with one another or with one or more vinylaromatic compounds having from 8 to 20 carbon atoms;
(c)—a ternary copolymer obtained by copolymerization of ethylene and of an α-olefin having from 3 to 6 carbon atoms with a non-conjugated diene monomer having from 6 to 12 carbon atoms, such as, for example, the elastomers obtained from ethylene and propylene with a non-conjugated diene monomer of the abovementioned type, such as, especially, 1,4-hexadiene, ethylidenenorbornene or dicyclopentadiene;
(d)—a copolymer of isobutene and of isoprene (butyl rubber) and also the halogenated versions, in particular chlorinated or brominated versions, of this type of copolymer.

Although it applies to any type of diene elastomer, a person skilled in the art of tyres will understand that the present invention is preferably employed with essentially unsaturated diene elastomers, in particular of the above type (a) or (b).

The following are especially suitable as conjugated dienes: 1,3-butadiene, 2-methyl-1,3-butadiene, 2,3-di(C₁-C₅ alkyl)-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, an aryl-1,3-butadiene, 1,3-pentadiene or 2,4-hexadiene. By way of vinylaromatic compounds, the following are for example suitable: styrene, ortho-, meta- or para-methylstyrene, the “vinyltoluene” commercial mixture, para-(tert-butyl)styrene, methoxystyrenes, chlorostyrenes, vinylmesitylene, divinylbenzene or vinylnaphthalene.

The copolymers may contain between 99% and 20% by weight of diene units and between 1% and 80% by weight of vinylaromatic units.

The abovementioned elastomers may have any microstructure, which depends on the polymerization conditions used, especially on the presence or absence of a modifying and/or randomizing agent and on the amounts of modifying and/or randomizing agent employed. The elastomers can, for example, be block, random, sequential or microsequential elastomers and can be prepared in dispersion or in solution; they can be coupled and/or star-branched or else functionalized with a coupling and/or star-branching or functionalization agent. For coupling to carbon black, mention may for example be made of functional groups comprising a C—Sn bond or aminated functional groups, such as aminobenzophenone, for example; for coupling to a reinforcing inorganic filler such as silica, mention may for example be made of silanol functional groups or polysiloxane functional groups having a silanol end (such as described, for example, in FR 2 740 778 or U.S. Pat. No. 6,013,718 and WO 2008/141702), alkoxysilane groups (such as described, for example, in FR 2 765 882 or U.S. Pat. No. 5,977,238), carboxyl groups (such as described, for example, in WO 01/92402 or U.S. Pat. No. 6,815,473, WO 2004/096865 or US 2006/0089445) or else polyether groups (such as described, for example, in EP 1 127 909 or U.S. Pat. No. 6,503,973, WO 2009/000750 and WO 2009/000752).

As functional elastomers, mention may also be made of those prepared using a functional initiator, especially those bearing an amine or tin functional group (see, for example, WO 2010/072761).

Mention may also be made, as other examples of functionalized elastomers, of elastomers (such as SBR, BR, NR or IR) of the epoxidized type.

The diene elastomer of the composition in accordance with the invention is preferentially selected from the group of highly unsaturated diene elastomers consisting of polybutadienes (abbreviated to “BRs”), synthetic polyisoprenes (IRs), natural rubber (NR), butadiene copolymers, isoprene copolymers and the mixtures of these elastomers.

Such copolymers are more preferentially selected from the group consisting of butadiene/styrene copolymers (SBRs), isoprene/butadiene copolymers (BIRs), isoprene/styrene copolymers (SIRs) and isoprene/butadiene/styrene copolymers (SBIRs).

According to a specific embodiment, the diene elastomer is predominantly (i.e., for more than 50 phr) an SBR, whether an SBR prepared in emulsion (“ESBR”) or an SBR prepared in solution (“SSBR”), or an SBR/BR, SBR/NR (or SBR/IR), BR/NR (or BR/IR) or also SBR/BR/NR (or SBR/BR/IR) blend (mixture). In the case of an SBR elastomer (ESBR or SSBR), use is especially made of an SBR having a moderate styrene content, for example of between 10% and 35% by weight, or a high styrene content, for example from 35% to 55%, a content of vinyl bonds of the butadiene part of between 15% and 70%, a content (mol %) of trans-1,4 bonds of between 15% and 75% and a Tg of between −10° C. and −65° C., preferably of greater than or equal to −50° C.

The diene elastomer of the composition preferentially represents at least 50% by weight of all the elastomers present in the composition.

The elastomer matrix of the composition in accordance with the invention more preferentially comprises at least one SBR at a content ranging from 60 to 100 phr, more preferentially from 80 to 100 phr.

In particular, the SBR may be used in a blend with natural rubber or a synthetic polyisoprene, present at a content ranging from 1 to 40 phr and preferentially ranging from 5 to 25 phr.

The composition according to the invention may contain one or more synthetic elastomers other than diene elastomers, or even with polymers other than elastomers, for example thermoplastic polymers.

### Reinforcing Filler

The composition according to the invention comprises at least, as reinforcing filler, hexagonal boron nitride of nanometric mean size, typically from 1 to 500 nm, preferably from 5 to 350 nm and even more preferentially from 10 to 250 nm.

Boron nitrides, the BET specific surface area of which is greater than or equal to 10 m²/g, preferably greater than or equal to 15 m²/g and even more preferentially greater than or equal to 20 m²/g, are suitable for the invention.

As boron nitride suitable for the invention, mention may be made of the boron nitrides sold by MK Impex Corp. under the trade name MK-hBN-N70, having a BET specific surface area of 25 m²/g and a particle size of 70 nm, and MK-hBN-050, having a BET specific surface area of 20 m²/g and a particle size of 500 nm, from ESK Ceramics GmbH&Co under the trade name Boronid SCPI.

The boron nitride advantageously represents the predominant reinforcing filler, and the boron nitride is preferentially the only reinforcing filler.

The boron nitride has a nanometric mean size, that is to say a size strictly less than 1 micrometre. The boron nitride is more particularly chosen to have a mean size of less than or equal to 500 nanometres.

However, the boron nitride may be used in a blend with other fillers, especially with an organic filler and/or an inorganic filler.

As organic filler, carbon blacks are particularly suitable, especially the reinforcing carbon blacks of the 100, 200 or 300 series (ASTM grades), such as, for example, the N115, N134, N234, N326, N330, N339, N347 or N375 blacks, or else, depending on the applications targeted, the blacks of higher series (for example, N400, N660, N683 or N772).

The term “reinforcing inorganic filler” should be understood here to mean, in a known way, any inorganic or mineral filler, irrespective of its colour and its origin (natural or synthetic), also known as “white filler”, “clear filler” or else “non-black filler”, in contrast to carbon black, this inorganic filler being capable of reinforcing, by itself, without means other than an intermediate coupling agent, a rubber composition intended for the manufacture of a tyre tread, in other words capable of replacing, in its reinforcing role, a conventional tyre-grade carbon black for a tread. Such a filler is generally characterized by the presence of functional groups, especially hydroxyl (—OH) functional groups, at its surface, requiring in that regard the use of a coupling agent or system intended to provide a stable chemical bond between the isoprene elastomer and said filler.

Preferentially, the reinforcing inorganic filler is a filler of the silica, alumina, silica-alumina or titanium oxide type, or a mixture of these types of fillers.

The silica (SiO₂) used can be any reinforcing silica known to those skilled in the art, especially any precipitated or pyrogenic silica having a BET surface area and a CTAB specific surface area both of less than 450 m²/g, preferably from 30 to 400 m²/g.

The total content of reinforcing filler preferably ranges from 30 to 350 phr, preferably from 50 to 300 phr, and even more preferentially from 60 to 250 phr.

According to a preferred variant embodiment of the invention, the boron nitride is the predominant reinforcing filler of the composition; the boron nitride is preferably the only reinforcing filler of the composition.

According to a preferred variant embodiment of the invention, the boron nitride is used in a blend with another reinforcing filler, this other reinforcing filler being present in the composition at a content of less than or equal to 30 phr.

As a function of the targeted application, inert (i.e. non-reinforcing) fillers, such as particles of clay, bentonite, talc, chalk, kaolin, at a content of less than or equal to 10 phr and preferentially less than or equal to 5 phr, may also be added to the reinforcing filler described above.

### Coupling Agent

In order to couple the reinforcing inorganic fillers to the diene elastomer, use is made, in a well-known way, of an at least bifunctional coupling agent (or bonding agent) intended to provide a satisfactory connection, of chemical and/or physical nature, between the inorganic filler (surface of its particles) and the diene elastomer. Use is made in particular of at least bifunctional organosilanes or polyorganosiloxanes.

Surprisingly, the applicant has observed that the presence of coupling agents conventionally used with inorganic fillers such as silica made it possible, in combination with the boron nitride, to improve the properties of hysteresis and of erosion resistance of the corresponding rubber composition.

Use is especially made of silane polysulphides, referred to as “symmetrical” or “asymmetrical” depending on their specific structure, such as described, for example, in applications WO 03/002648 (or US 2005/016651) and WO 03/002649 (or US 2005/016650).

Particularly suitable, without the definition below being limiting, are silane polysulphides corresponding to the following general formula (I):

Z-A-Sₓ-A-Z, in which: (I)
x is an integer from 2 to 8 (preferably from 2 to 5);
the A symbols, which are identical or different, represent a divalent hydrocarbon radical (preferably a C₁-C₁₈ alkylene group or a C₆-C₁₂ arylene group, more particularly a C₁-C₁₀, especially C₁-C₄, alkylene, in particular propylene);
the Z symbols, which are identical or different, correspond to one of the three formulae below:

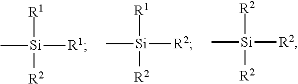

in which:
the R¹ radicals, which are substituted or unsubstituted and identical to or different from one another, represent a C₁-C₁₈ alkyl, C₅-C₁₈ cycloalkyl or C₆-C₁₈ aryl group (preferably C₁-C₆ alkyl, cyclohexyl or phenyl groups, especially C₁-C₄ alkyl groups, more particularly methyl and/or ethyl);
the R² radicals, which are substituted or unsubstituted and identical to or different from one another, represent a C₁-C₁₈ alkoxyl or C₅-C₁₈ cycloalkoxyl group (preferably a group chosen from C₁-C₈ alkoxyls and C₅-C₈ cycloalkoxyls, more preferentially still a group chosen from C₁-C₄ alkoxyls, in particular methoxyl and ethoxyl).

In the case of a mixture of alkoxysilane polysulphides corresponding to the above formula (I), especially customary commercially available mixtures, the mean value of “x” is a fractional number preferably of between 2 and 5, more preferentially close to 4. However, the invention can also advantageously be carried out, for example, with alkoxysilane disulphides (x=2).

Mention will more particularly be made, as examples of silane polysulphides, of bis((C₁-C₄)alkoxyl(C₁-C₄)alkylsilyl(C₁-C₄)alkyl) polysulphides (in particular disulphides, trisulphides or tetrasulphides), such as, for example, bis(3-trimethoxysilylpropyl) or bis(3-triethoxysilylpropyl) polysulphides. Use is made in particular, among these compounds, of bis(3-triethoxysilylpropyl) tetrasulphide, abbreviated to TESPT, of formula [(C₂H₅O)₃Si(CH₂)₃S₂]₂, or bis(3-triethoxysilylpropyl) disulphide, abbreviated to TESPD, of formula [(C₂H₅O)₃Si(CH₂)₃S]₂. Mention will also be made, as preferential examples, of bis(mono(C₁-C₄)alkoxyldi(C₁-C₄)alkylsilylpropyl) polysulphides (in particular disulphides, trisulphides or tetrasulphides), more particularly bis(monoethoxydimethylsilylpropyl) tetrasulphide, such as described in the abovementioned patent application WO 02/083782 (or U.S. Pat. No. 7,217,751).

Mention will especially be made, as examples of coupling agents other than an alkoxysilane polysulphide, of bifunctional POSs (polyorganosiloxanes), or else of hydroxysilane polysulphides (R²═OH in the above formula I), such as described, for example, in Patent Applications WO 02/30939 (or U.S. Pat. No. 6,774,255), WO 02/31041 (or US 2004/051210) and WO2007/061550, or else of silanes or POSs bearing azodicarbonyl functional groups, such as described, for example, in Patent Applications WO 2006/125532, WO 2006/125533 and WO 2006/125534.

As examples of other silane sulphides, mention will be made, for example, of the silanes bearing at least one thiol (—SH) function (referred to as mercaptosilanes) and/or at least one blocked thiol function, as described for example in patents or patent applications U.S. Pat. No. 6,849,754, WO 99/09036, WO 2006/023815, WO 2007/098080, WO 2010/072685 and WO 2008/055986.

Of course, use might also be made of mixtures of the coupling agents described above, as described especially in the abovementioned application WO 2006/125534.

The content of coupling agent is advantageously less than 20 phr, it being understood that it is generally desirable to use as little as possible thereof. Typically, the content of coupling agent represents from 0.05% to 10% by weight relative to the amount of boron nitride, preferably from 0.1 to 7% by weight and even more preferentially from 0.2 to 5% by weight.

This content is easily adjusted by those skilled in the art depending on the content of filler used in the composition.

### Plasticizing System

The rubber compositions of the invention use a plasticizing system which may especially consist of a plasticizing oil and/or a plasticizing resin.

Thus, these compositions comprise an extender oil (or plasticizing oil), the usual function of which is to improve the processability by lowering the Mooney plasticity.

At ambient temperature (23° C.), these oils, which are more or less viscous, are liquids (that is to say, as a reminder, substances which have the ability to eventually assume the shape of their container), in contrast especially to resins or rubbers, which are by nature solids.

Preferably, the extender oil is selected from the group consisting of polyolefinic oils (that is to say, resulting from the polymerization of monoolefinic or diolefinic olefins), paraffinic oils, naphthenic oils (of low or high viscosity), aromatic oils, mineral oils and the mixtures of these oils.

The number-average molecular weight (Mn) of the extender oil is preferentially between 200 and 25 000 g/mol, more preferentially still between 300 and 10 000 g/mol. For excessively low Mn weights, there is a risk of the oil migrating outside the composition, whereas excessively high weights can result in excessive stiffening of this composition. An Mn weight of between 350 and 4000 g/mol, in particular between 400 and 3000 g/mol, has proved to constitute an excellent compromise for the targeted applications, in particular for use in a tyre.

The number-average molecular weight (Mn) of the extender oil is determined by SEC, the sample being dissolved beforehand in tetrahydrofuran at a concentration of approximately 1 g/l; the solution is then filtered through a filter with a porosity of 0.45 μm before injection. The apparatus is the Waters Alliance chromatographic line. The elution solvent is tetrahydrofuran, the flow rate is 1 ml/min, the temperature of the system is 35° C. and the analytical time is 30 min. A set of two Waters columns with the Styragel HT6E name is used. The injected volume of the solution of the polymer sample is 100 μl. The detector is a Waters 2410 differential refractometer and its associated software, for making use of the chromatographic data, is the Waters Millennium system. The calculated average molar masses are relative to a calibration curve produced with polystyrene standards.

The rubber compositions of the invention may also use a plasticizing hydrocarbon resin, the Tg, glass transition temperature, of which is greater than 20° C. and the softening point of which is less than 170° C., as explained in detail below.

In a manner known to those skilled in the art, the name “plasticizing resin” is reserved in the present application, by definition, for a compound which is, on the one hand, solid at ambient temperature (23° C.) (in contrast to a liquid plasticizing compound, such as an oil) and, on the other hand, compatible (that is to say, miscible at the content used, typically of greater than 5 phr) with the rubber composition for which it is intended, so as to act as a true diluting agent.

Hydrocarbon resins are polymers well known to those skilled in the art which are thus miscible by nature in elastomer compositions, when they are additionally classed as “plasticizing”.

They have been widely described in the patents or patent applications mentioned in the introduction to the present document and also, for example, in the work entitled “Hydrocarbon Resins” by R. Mildenberg, M. Zander and G. Collin (New York, VCH, 1997, ISBN 3-527-28617-9), Chapter 5 of which is devoted to their applications, especially in the tyre rubber field (5.5. “Rubber Tires and Mechanical Goods”).

They may be aliphatic, naphthenic or aromatic or else of the aliphatic/naphthenic/aromatic type, that is to say based on aliphatic and/or naphthenic and/or aromatic monomers. They may be natural or synthetic and based or not based on petroleum (if this is the case, they are also known under the name of petroleum resins). They are preferentially exclusively hydrocarbon-based, that is to say that they comprise only carbon and hydrogen atoms.

The plasticizing hydrocarbon resin preferably has at least one, more preferentially all, of the following characteristics:
a number-average molecular weight (Mn) of between 400 and 2000 g/mol;
a polydispersity index (PDI) of less than 3 (reminder: PDI=Mw/Mn with Mw being the weight-average molecular weight).

More preferentially, this plasticizing hydrocarbon resin has at least one, more preferentially still all, of the following characteristics:
a Tg of greater than 20° C.;
a weight Mn of between 500 and 1500 g/mol;
a PDI index of less than 2.

The glass transition temperature Tg is measured in a known way by DSC (Differential Scanning calorimetry) according to Standard ASTM D3418 (1999) and the softening point is measured according to Standard ASTM E-28.

The macrostructure (Mw, Mn and PDI) of the hydrocarbon resin is determined by size exclusion chromatography (SEC); solvent tetrahydrofuran; temperature 35° C.; concentration 1 g/l; flow rate 1 ml/min; solution filtered through a filter with a porosity of 0.45 μm before injection; Moore calibration with polystyrene standards; set of 3 Waters columns in series (Styragel HR4E, HR1 and HR0.5); detection by differential refractometer (Waters 2410) and its associated operating software (Waters Empower).

According to a particularly preferential embodiment, the plasticizing hydrocarbon resin is selected from the group consisting of cyclopentadiene (abbreviated to CPD) or dicyclopentadiene (abbreviated to DCPD) homopolymer or copolymer resins, terpene homopolymer or copolymer resins, C₅ fraction homopolymer or copolymer resins and the mixtures of these resins.

Use is preferentially made, among the above copolymer resins, of those selected from the group consisting of (D)CPD/vinylaromatic copolymer resins, (D)CPD/terpene copolymer resins, (D)CPD/C₅ fraction copolymer resins, terpene/vinylaromatic copolymer resins, C₅ fraction/vinylaromatic copolymer resins and the mixtures of these resins.

The term “terpene” groups together here, in a known way, α-pinene, β-pinene and limonene monomers; use is preferably made of a limonene monomer, a compound which exists, in a known way, in the form of three possible isomers: L-limonene (laevorotatory enantiomer), D-limonene (dextrorotatory enantiomer) or else dipentene, the racemate of the dextrorotatory and laevorotatory enantiomers.

Suitable as vinylaromatic monomer are, for example: styrene, α-methylstyrene, ortho-, meta- or para-methyl styrene, vinyltoluene, para-(tert-butyl)styrene, methoxystyrenes, chlorostyrenes, vinylmesitylene, divinylbenzene, vinylnaphthalene or any vinylaromatic monomer resulting from a C₉ fraction (or more generally from a C₈ to C₁₀ fraction). Preferably, the vinylaromatic compound is styrene or a vinylaromatic monomer resulting from a C₉ fraction (or more generally from a C₈ to C₁₀ fraction). Preferably, the vinylaromatic compound is the minor monomer, expressed as molar fraction, in the copolymer under consideration.

According to a more particularly preferential embodiment, the plasticizing hydrocarbon resin is selected from the group consisting of (D)CPD homopolymer resins, (D)CPD/styrene copolymer resins, polylimonene resins, limonene/styrene copolymer resins, limonene/D(CPD) copolymer resins, C₅ fraction/styrene copolymer resins, C₅ fraction/C₉ fraction copolymer resins and the mixtures of these resins.

The preferential resins above are well known to those skilled in the art and are commercially available, for example sold as regards:

polylimonene resins: by DRT under the name Dercolyte L120 (Mn=625 g/mol; Mw=1010 g/mol; PDI=1.6; Tg=72° C.) or by Arizona under the name Sylvagum TR7125C (Mn=630 g/mol; Mw=950 g/mol; PDI=1.5; Tg=70° C.);
C₅ fraction/vinylaromatic copolymer resins, especially C₅ fraction/styrene or C₅ fraction/C₉ fraction copolymer resins: by Neville Chemical Company under the names Super Nevtac 78, Super Nevtac 85 and Super Nevtac 99, by Goodyear Chemicals under the name Wingtack Extra, by Kolon under the names Hikorez T1095 and Hikorez T1100 or by Exxon under the names Escorez 2101 and ECR 373;
limonene/styrene copolymer resins: by DRT under the name Dercolyte TS 105 from DRT or by Arizona Chemical Company under the names ZT115LT and ZT5100.

The content of plasticizing system ranges from 5 to 150 phr, preferably from 10 to 130 phr, and even more preferentially between 20 and 100 phr. Below the minimum indicated, the targeted technical effect can prove to be insufficient whereas, above the maximum, the tackiness of the compositions in the raw state, with regard to the compounding devices, can in some cases become unacceptable from the industrial viewpoint.

According to one embodiment, the plasticizing system predominantly comprises a plasticizing resin.

According to another embodiment of the invention, the plasticizing system solely comprises a plasticizing resin.

### Crosslinking System

The crosslinking system is preferentially a vulcanization system, that is to say a system based on sulphur (or on a sulphur-donating agent) and on a primary vulcanization accelerator. Various known secondary vulcanization accelerators or vulcanization activators, such as zinc oxide, stearic acid or equivalent compounds, or guanidine derivatives (in particular diphenylguanidine), are added to this base vulcanization system, being incorporated during the first non-productive phase and/or during the productive phase, as described subsequently.

The sulphur is used at a preferential content of between 0.5 and 12 phr, in particular between 1 and 10 phr. The primary vulcanization accelerator is used at a preferential content of between 0.5 and 10 phr, more preferentially of between 0.5 and 5.0 phr.

Use may be made, as (primary or secondary) accelerator, of any compound capable of acting as accelerator for the vulcanization of diene elastomers in the presence of sulphur, especially accelerators of thiazole type, and also their derivatives, and accelerators of thiuram and zinc dithiocarbamate types. These accelerators are, for example, selected from the group consisting of 2-mercaptobenzothiazyl disulphide (abbreviated to “MBTS”), tetrabenzylthiuram disulphide (“TBZTD”), N-cyclohexyl-2-benzothiazolesulphenamide (“CBS”), N,N-dicyclohexyl-2-benzothiazolesulphenamide (“DCBS”), N-(tert-butyl)-2-benzothiazolesulphenamide (“TBBS”), N-(tert-butyl)-2-benzothiazolesulphenimide (“TBSP”), zinc dibenzyldithiocarbamate (“ZBEC”) and the mixtures of these compounds.

### Various Additives

The rubber compositions in accordance with the invention may also comprise all or some of the customary additives generally used in elastomer compositions intended for the manufacture of tyres, in particular of treads, such as, for example, protective agents such as antiozone waxes, chemical antiozonants, antioxidants, antifatigue agents, tackifying resins or processing aids such as described, for example, in application WO 02/10269.

### Manufacture of the Rubber Compositions

The rubber compositions of the invention are manufactured in appropriate mixers, using two successive phases of preparation according to a general procedure well known to those skilled in the art: a first phase of thermomechanical working or kneading (sometimes referred to as a “non-productive” phase) at high temperature, up to a maximum temperature of between 130° C. and 200° C., preferably between 145° C. and 185° C., followed by a second phase of mechanical working (sometimes referred to as a “productive” phase) at lower temperature, typically below 120° C., for example between 23° C. and 100° C., during which finishing phase the crosslinking or vulcanization system is incorporated.

### III. EXEMPLARY EMBODIMENTS OF THE INVENTION

The examples which follow make it possible to illustrate the invention; however, the invention cannot be limited to these examples alone.

### Preparation of the Rubber Compositions

The following tests are carried out in the following manner: the diene elastomer and then the filler (silica and/or boron nitride) are introduced into an internal mixer filled to 70%, the initial vessel temperature of which is approximately 90° C.; depending on the size of the volume it represents, the filler may be introduced in several stages. After one to two minutes of kneading, the various other ingredients, with the exception of the vulcanization system. Thermomechanical working is then carried out (non-productive phase) in one stage (total duration of the kneading equal to approximately 5 min), until a maximum “dropping” temperature of approximately 150° C. is reached. The mixture thus obtained is recovered and cooled and then the vulcanization system (sulphur and sulphenamide accelerator) is added on an external mixer (homofinisher) at 30° C., everything being mixed (productive phase) for approximately 5 to 6 min.

The compositions thus obtained are subsequently calendered, either in the form of slabs (thickness of 2 to 3 mm) or of thin sheets of rubber for the measurement of their physical or mechanical properties. The vulcanization (or curing) is carried out at 150° C. for 70 minutes.

### Test 1

The aim of this test is to show the improvement in the thermal conductivity and hysteresis properties of a composition according to the invention relative to two control compositions.

The three compositions were prepared in accordance with the process detailed in the previous paragraph, and have the same base formulation; they differ in terms of the nature and/or the content of reinforcing filler and the content of coupling agent.

More specifically, the compositions A1, A2 and C1 are defined as follows:
the control composition A1 is a “conventional” tyre tread composition comprising silica as reinforcing filler,
the control composition A2 is such that the fraction by volume (22%) of the composition A1 has been replaced by boron nitride, the composition having no coupling agent,
the composition C1 in accordance with the invention is identical to the composition A2 with the exception of the addition of coupling agent.

The formulations of these three compositions are presented in the following table 1, in which the amounts are expressed in phr, parts by weight per hundred parts of elastomer:

TABLE 1

| | Composition No. | | |
|---|---|---|---|
| | A1 | A2 | C1 |
| Elastomer (1) | 100 | 100 | 100 |
| Silica (2) | 85 | — | — |
| Boron nitride (3) | — | 97 | 97 |
| Coupling agent (4) | 7 | — | 2 |
| DPG (5) | 1.5 | — | — |
| Resin (6) | 35 | 35 | 35 |
| Antioxidant (7) | 2 | 2 | 2 |
| Zinc oxide | 2.5 | 2.5 | 2.5 |
| Stearic acid | 2 | 2 | 2 |
| Sulphenamide (8) | 2 | 2 | 2 |
| Sulphur | 1.5 | 1.5 | 1.5 |

(1) Copolymer comprising 27% styrene, and 24%-1,2 units (vinyl), 30% cis-1,4 units and 46% trans-1,4 units in the polybutadiene part (Tg −52° C.)
(2) Zeosil 1165MP silica from Solvay
(3) MK-hBN-N70 hBN boron nitride from MK Impex Corp
(4) SI266 coupling agent from Evonik
(5) Diphenylguanidine (Perkacit DPG from Flexsys)
(6) High Tg resin, Escorez 2173, from Exxon
(7) 6-PPD N-(1,3-dimethylbutyl)-N-phenyl-para-phenylenediamine (Santoflex 6-PPD from Solutia);
(8) N-cyclohexyl-2-benzothiazole sulphenamide (Santocure CBS from Solutia).

The properties obtained after curing (approximately 70 min at 150° C.) from these compositions are presented in the following table 2:

TABLE 2

| | Composition No. | | |
|---|---|---|---|
| | A1 | A2 | C1 |
| Thermal diffusivity (m²/s) | 0.144 | 0.255 | 0.255 |
| MSA100 (MPa) | 1.6 | 0.98 | 1.4 |
| MSA300/MSA100 | 1.5 | 0.86 | 1.24 |
| Tan (δ)ₘₐₓ | 0.33 | 0.25 | 0.19 |

It is observed, as expected by those skilled in the art, that the compositions A2 and C1 comprising boron nitrides have a much higher thermal diffusivity than the conventional control composition A1.

However, it is also noted, surprisingly, that A2 and C1 have a very significantly reduced hysteresis relative to the control composition A1, based on silica (despite the fact that silica-based compositions such as the composition A1 are known to have low hysteresis). Even more notably, is it observed that the composition C1 in accordance with the invention, comprising both boron nitride as reinforcing filler and a coupling agent, has a highly improved hysteresis both compared to the composition A1 and the composition A2.

It is observed that the reinforcement of the composition C1 in accordance with the invention remains significantly lower than that of the composition A1, but astonishingly it is very markedly better than the reinforcement of the composition A2. Indeed, a slight improvement in the reinforcement of the composition C1 relative to A2 could have been hoped for, given the presence of coupling agent, but not such a large improvement. Moreover, it is totally unexpected to observe that the combination of the boron nitride and the coupling agent of the composition C1 makes it possible to obtain a yet further lowered hysteresis relative to the composition A2.

### Test 2

The aim of this test is to show the improvement in the thermal conductivity, mechanical and hysteresis properties of several compositions in accordance with the invention having different contents of coupling agent relative to a control composition including the same amount of boron nitride but without the presence of coupling agent.

The different compositions of this test have a base formulation close to that of test 1, except for the fraction by volume of boron nitride, which is 30%.

These compositions A3 and C2 to C6 are defined as follows:
the control composition A3 is a tyre tread composition comprising boron nitride as reinforcing filler, but without coupling agent,
the composition C2 in accordance with the invention differs from the composition A3 by the presence of coupling agent (content of 0.5 phr),
the composition C3 in accordance with the invention differs from the composition C2 by the content of coupling agent (0.9 phr),
the composition C4 in accordance with the invention differs from the composition C2 by the content of coupling agent (1.3 phr),
the composition C5 in accordance with the invention differs from the composition C2 by the content of coupling agent (2 phr),
the composition C6 in accordance with the invention differs from the composition C2 by the content of coupling agent (3 phr).

The differences in formulation, in phr, between these compositions, are thus presented in the following table 3:

TABLE 3

| Composition No. | A3 | C2 | C3 | C4 | C5 | C6 |
|---|---|---|---|---|---|---|
| Elastomer (1) | 100 | 100 | 100 | 100 | 100 | 100 |
| Boron nitride (3) | 145 | 145 | 145 | 145 | 145 | 145 |
| Coupling agent (4) | — | 0.5 | 0.9 | 1.3 | 2.0 | 3.0 |
| Resin (6) | 35 | 35 | 35 | 35 | 35 | 35 |
| Antioxidant (7) | 1.5 | 1.5 | 1.5 | 1.5 | 1.5 | 1.5 |
| Zinc oxide | 2.5 | 2.5 | 2.5 | 2.5 | 2.5 | 2.5 |
| Stearic acid | 2 | 2 | 2 | 2 | 2 | 2 |
| Sulphenamide (8) | 2 | 2 | 2 | 2 | 2 | 2 |
| Sulphur | 1.5 | 1.5 | 1.5 | 1.5 | 1.5 | 1.5 |
| % by weight of | 0 | 0.34 | 0.62 | 0.9 | 1.4 | 2 |
| coupling agent relative | | | | | | |
| to the reinforcing filler | | | | | | |

The properties obtained after curing (approximately 70 min at 150° C.) from these compositions were measured.

These compositions all have a consistent equivalent thermal diffusivity, which is very good.

The other properties obtained are presented in the following Table 4:

TABLE 4

| Composition No. | A3 | C2 | C3 | C4 | C5 | C6 |
|---|---|---|---|---|---|---|
| MSA300/MSA100 | 0.72 | 0.85 | 0.88 | 0.92 | 0.96 | 0.98 |
| MSA100 (MPa) | 1.77 | 2.22 | 2.37 | 2.61 | 2.66 | 3.22 |
| Tan (δ)ₘₐₓ | 0.35 | 0.31 | 0.27 | 0.25 | 0.24 | 0.21 |
| Thermal diffusivity | 0.40 | — | — | — | 0.38 | 0.38 |
| (m²/s) | | | | | | |

It is observed, as in the previous example, that the presence of coupling agent combined with that of boron nitride (compositions C2 to C6) makes it possible to markedly improve the reinforcement (MSA300/MSA100) of the compositions and to lower the hysteresis thereof in comparison with the composition A3 which does not include coupling agent.

It is also observed that increasing the amount of coupling agent significantly improves the stiffness and hysteresis properties, more particularly for the compositions C4 and C5.

Moreover, the presence of a large amount (1.4 and 2% by weight) of coupling agent only very slightly affects the thermal conductivity of the compositions C5 and C6 in accordance with the invention, relative to that measured in the composition A3.

1.-16. (canceled)

17. A tire comprising at least one rubber composition based on at least one diene elastomer, a reinforcing filler, a plasticizing system and a crosslinking system,
wherein the composition comprises hexagonal boron nitride having a BET specific surface area of greater than or equal to 10 m²/g as reinforcing filler at a content ranging from 30 to 350 parts per hundred parts of elastomer, phr, and a coupling agent capable of binding the boron nitride to the at least one diene elastomer.

18. The tire according to claim 17, wherein the boron nitride has a specific surface area of greater than or equal to 15 m²/g.

19. The tire according to claim 18, wherein the boron nitride has a specific surface area of greater than or equal to 20 m²/g.

20. The tire according to claim 17, wherein the at least one diene elastomer is selected from the group consisting of polybutadienes, synthetic polyisoprenes, natural rubber, butadiene copolymers, isoprene copolymers and mixtures thereof.

21. The tire according to claim 17, wherein the at least one diene elastomer is a styrene/butadiene copolymer.

22. The tire according to claim 17, wherein the at least one diene elastomer represents at least 50% by weight of all the elastomers present in the composition.

23. The tire according to claim 17, wherein the content of boron nitride ranges from 60 to 250 phr.

24. The tire according to claim 17, wherein the boron nitride is the predominant reinforcing filler of the composition.

25. The tire according to claim 24, wherein the boron nitride is the only reinforcing filler of the composition.

26. The tire according to claim 24, wherein the boron nitride is used in a blend with another reinforcing filler, the another reinforcing filler being present in the composition at a content of less than or equal to 30 phr.

27. The tire according to claim 17, wherein a content of coupling agent represents from 0.1 to 7% by weight relative to the amount of boron nitride.

28. The tire according to claim 27, wherein the content of coupling agent represents from 0.2 to 5% by weight.

29. The tire according to claim 17, wherein a content of plasticizing system ranges from 5 to 150 phr.

30. The tire according to claim 17, wherein the content of plasticizing system ranges from 10 to 130 phr.

31. The tire according to claim 30, wherein the content of plasticizing system ranges from 20 to 100 phr.

32. The tire according to claim 17, wherein the plasticizing system predominantly comprises a plasticizing resin with a Tg of greater than 20° C.

33. The tire according to claim 32, wherein the plasticizing system solely comprises one plasticizing resin.

34. The tire according to claim 17, wherein the composition at least partially constitutes the tread.
